(19) United States
(12) Patent Application Publication
(10) Pub. No.: US 2014/0167763 A1
(43) Pub. Date: Jun. 19, 2014

(54) TRACER WIRE CONNECTOR DEVICES AND METHODS FOR USE

(71) Applicant: CONSOLIDATED EDISON COMPANY OF NEW YORK, INC., New York, NY (US)

(72) Inventor: Natalino J. Giraldi, Brox, NY (US)

(73) Assignee: Consolidated Edison Company of New York, Inc., New York, NY (US)

(21) Appl. No.: 13/715,328

(22) Filed: Dec. 14, 2012

(51) Int. Cl. H01R 13/73; G01V 3/00

(52) U.S. Cl. CPC H01R 13/73; G01V 3/00
USPC 324/326; 439/574

(57) ABSTRACT

Devices for and methods of connecting a buried tracer wire to a buried utility pipe are described. The devices and methods include providing a tracer wire connector connected to a clamp, attaching the clamp to a metal portion of the buried utility pipe, and placing an end of the buried tracer wire in the tracer wire connector so that a conductor in the tracer wire is in electrical communication with the buried utility pipe. A sacrificial anode may be conductively attached to the tracer wire connector.

### FIELD

This application relates generally to location of underground utilities. More specifically, this application relates to devices and methods for use with a tracer wire for locating buried utility (gas, water, sewer, or electric) distribution lines.

### BACKGROUND

Natural gas distribution has become an important utility and a key provider for heat around the world. Maintenance and repair of natural gas (or gases) lines can be important in certain instances due to the danger of gas leaks and the critical importance to customers of natural gas in continued supply for many uses, such as cooking, air heating, use by water heaters, clothes dryers, etc. Similarly, distribution systems for other utilities (including water, sewer, or electric) also need repair or replacement.

Some utility-13 including gas—lines are buried along streets that also include other utilities. Often, to repair a damaged or clogged gas line (such as a gas main or branch), a hole must be excavated and the pipe checked or replaced. The current technology to determine the exact locations of the gas mains, especially at elevated pressures, in a confident manner may be performed using a tracer wire, which provides a location based on a signal that is passed through the tracer wire. Tracer wires are commonly installed with replacing or installing new utility lines they are often made from HDPE (high-density polyethylene), which can be difficult to locate underground without a tracer wire.

Some technicians have been trained to approximate where the gas lines should be located and to provide mark outs on the ground in those locations. The mark outs, even when provided, are often based upon map accuracy and the expertise of the technician. The technician often picks up other utilities normally running alongside gas mains, which the repair crews do not want to disturb. Often, errors in the mark outs can still be off by as much as up to 3 to 4 feet, causing extra time and effort in excavation and avoiding other utilities, along with added costs in repairing roads and service delays.

### SUMMARY

This application describes devices and methods for use with a tracer wire that is buried in underground utilities. An underground tracer wire device may be configured to connect a tracer wire to an underground utility pipe and may include a clamp and a wire connector coupled to the clamp. The wire connector may include a conductive plate that is in electrical communication with an interior portion of the clamp. The tracer wire device may be attached to the underground utility pipe. The underground utility pipe may be a natural gas supply line.

In some embodiments, the wire connector may electrically couple an underground tracer wire to the underground utility pipe. The underground utility pipe may comprise continuous section formed of plastic and at least one section formed of metal. The clamp may be a screw-type clamp formed metal. The wire connector may be coupled to the clamp with an electrically conductive rivet. A sacrificial anode may also be electrically coupled to the wire connector. The sacrificial anode may include at least one of zinc and magnesium, or other suitable material to prevent corrosion of other components. The wire connector may further comprise a base and a cap coupled to the base with a strap such that when the cap is placed on the base, the tracer wire is electrically connected to the conductive plate.

In some embodiments, a method of connecting a buried tracer wire to a buried utility pipe may include providing a tracer wire connector connected to a clamp, attaching the clamp to a metal portion of the buried utility pipe, and placing an end of the buried tracer wire in the tracer wire connector such that a conductor in the tracer wire is in electrical communication with the buried utility pipe. The method may also include covering the end of buried the tracer wire with a cap such that covering the end of the buried tracer wire places the buried tracer wire in the electrical communication with the buried utility pipe. The tracer wire connector may also include a conductive plate coupled to the clamp with a conductive contact, and the conductive contact may be in direct physical contact with the metal portion of the buried utility pipe.

In some embodiments, the buried utility pipe may include a non-conductive section concurrent with at least a portion of the buried tracer wire. The method may also include electrically attaching a sacrificial anode to the tracer wire connector, the sacrificial anode including at least one of zinc and magnesium. The sacrificial anode may be attached to the tracer wire connector using a jacketed wire. Some methods may also include attaching a second clamp to a second metal portion of the buried utility pipe, and placing a second end of the buried tracer wire in a second tracer wire connector such that the conductor in the tracer wire is in electrical communication with the metal portion of the buried utility pipe and the second metal portion of the buried utility pipe. The buried utility pipe comprises a section between the metal portion of the buried utility pipe and the second metal portion of the buried utility pipe formed of HDPE.

### BRIEF DESCRIPTION OF THE DRAWINGS

The following description can be better understood in light of the Figures, in which:

FIGS. 1 and 2 show isometric views of some embodiments of an exemplary tracer wire connector device;

FIG. 3 shows a cross-sectional view of some embodiments of the exemplary tracer wire connector device of FIG. 1;

FIG. 4 shows an isometric views of some embodiments of an exemplary tracer wire connector device; and

FIGS. 5 and 6 show some embodiments of an exemplary tracer wire connector device installed on a utility line;.

The Figures illustrate specific aspects of tracer wire connector devices for use with buried utility lines and methods for making and using such devices. Together with the following description, the Figures demonstrate and explain the principles of the methods and structures produced through these methods. In the drawings, the thickness of layers and regions are exaggerated for clarity. The same reference numerals in different drawings represent the same element, and thus their descriptions will not be repeated. As the terms on, attached to, or coupled to are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

### DETAILED DESCRIPTION

The following description supplies specific details in order to provide a thorough understanding. Nevertheless, the skilled artisan would understand that the described tracer wire connector devices for use with utility lines and methods for making and using such devices can be implemented and used without employing these specific details. Indeed, the tracer wire connector devices can be placed into practice by modifying the illustrated devices and methods and can be used in conjunction with any other apparatus and techniques conventionally used in the industry. For example, while the description below focuses on methods of tying plastic gas lines to existing metal gas lines, the devices and methods described may be used with any buried utility having a tracer wire.

Some embodiments of the tracer wire connector devices for use with utility lines and methods for making and using such devices are described herein and illustrated in the Figures. These devices and methods can be used with any utility line, including gas, water, sewer, electric, or any other utility. In some embodiments, these devices and methods can be used with gas lines.

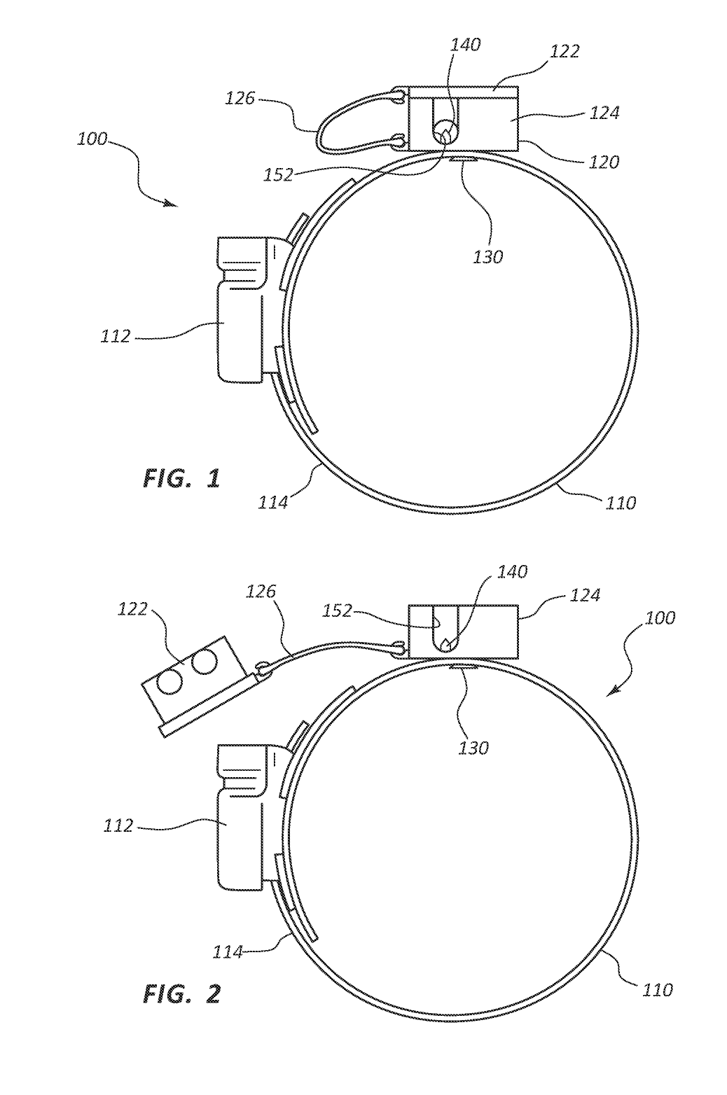

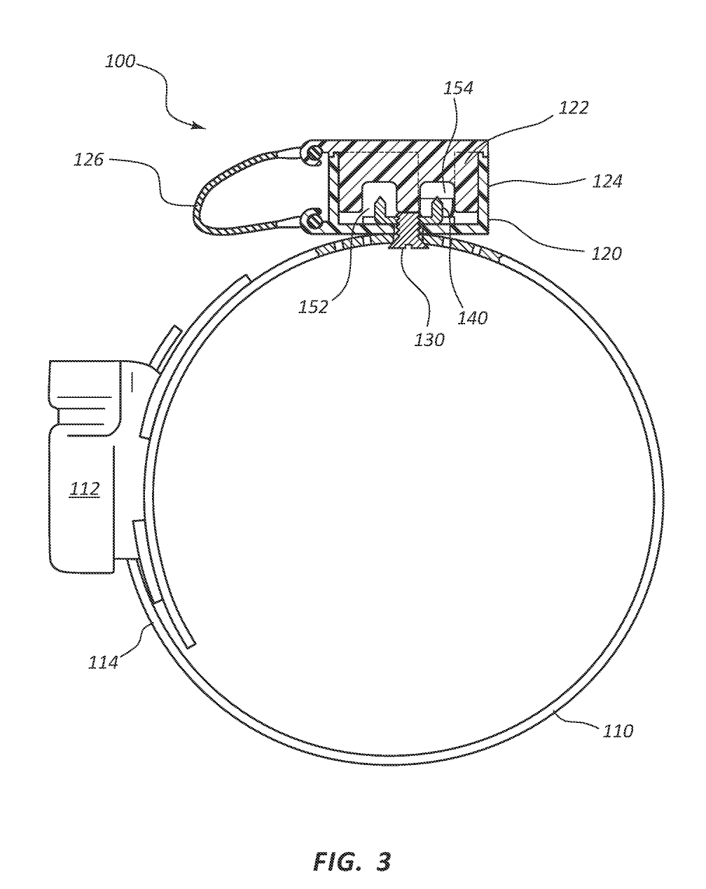

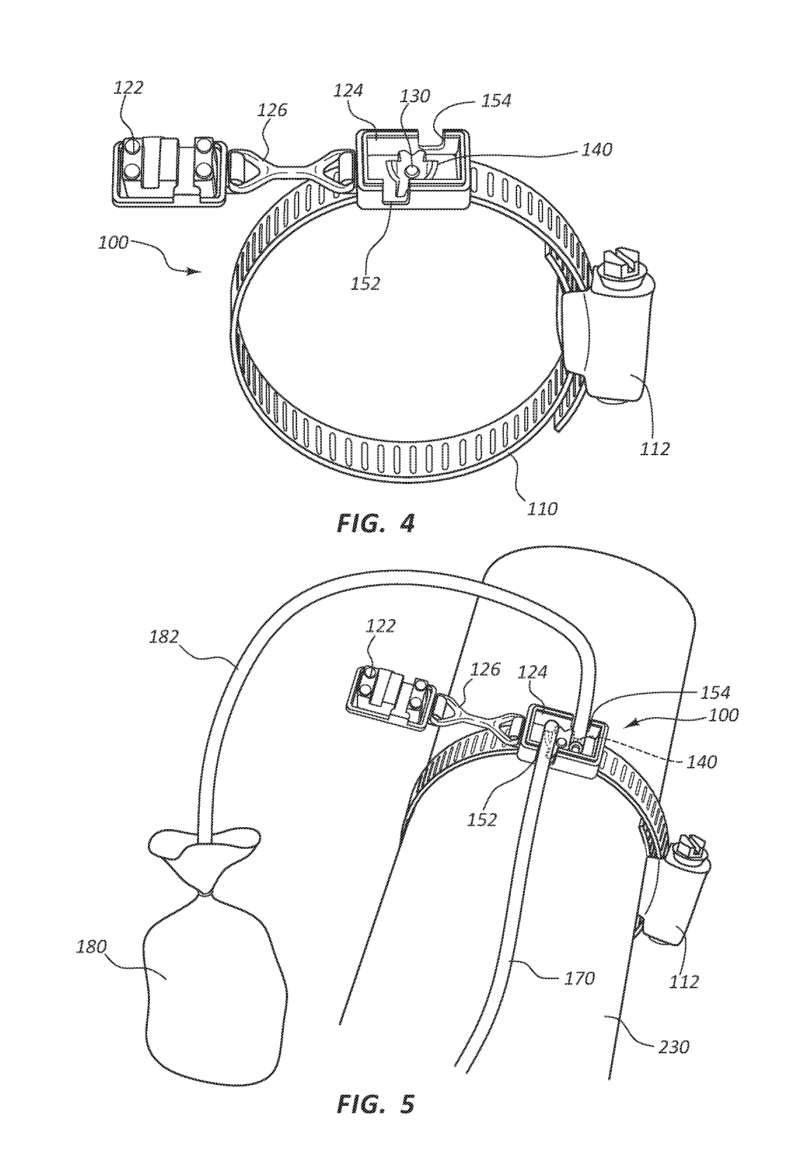

FIGS. 1-4 illustrate some embodiments of a tracer wire connector device 100. The tracer wire connector device 100 may include a clamp 110 and a wire terminal 120. The wire terminal 120 may be functionally attached to the clamp 100 to provide electrical connectivity between wires affixed to the wire terminal 120 and the contact 130, as well as any conductive object that is electrically connected to the contact 130. The wire connector device 100 may be used to tie a tracer wire installed with plastic pipe to existing metal pipes.

In some circumstances, existing utility mains lines may be replaced with plastic lines and a tracer wire, or new lines with a tracer wire may be placed that tie into the existing service lines that lead from the utility main to individual buildings or customers. By tying the tracer wire to existing metal lines or service lines, the signal transmitted on the tracer wire may be transmitted along the existing metal lines as well, making an entire system detectable with signal detection equipment for finding buried utilities.

As shown in FIGS. 1-2, the tracer wire connector device 100 contains a clamp 110. The clamp 110 may be a screw-type clamp, and Oetiker-type clamp, a zip-tie, or any other type of pipe clamp or clamping mechanism. The illustrated embodiments of the clamp 110 are shown as screw-type clamps with a screw connector 112 and a band 114. In such embodiments, threads from the screw connector 112 may engage with slots in the band 114 to adjust the diameter of the claim 110 and hold the clamp in place. The clamp 110 may be formed of metal or any other material, such as plastic, as long as the signal wire is placed in electrical contact with any metal pipe to which the clamp may be attached.

A shown in FIGS. 1-2, the tracer wire connector device 100 also contains a wire terminal 120. The wire terminal 120 may include a base 124 and a cap 122 attached to the base 124 with a strap 126. The base 124 may contain wire openings 152, 154 that are configured appropriately to accept the tracer wire. In some configurations, the base 124 may generally have a box shape with a portion of the cap 122 being designed to fit within the box shape and trap tracer wires in the wire terminal 120. The base 124 and the cap 122 may be formed of plastic, or other non-corrosive material, to protect tracer wires and other components of the wire terminal 120. The strap 126 may be provided as a convenience to make the cap 122 easily accessible with installing the signal wire tie device 100.

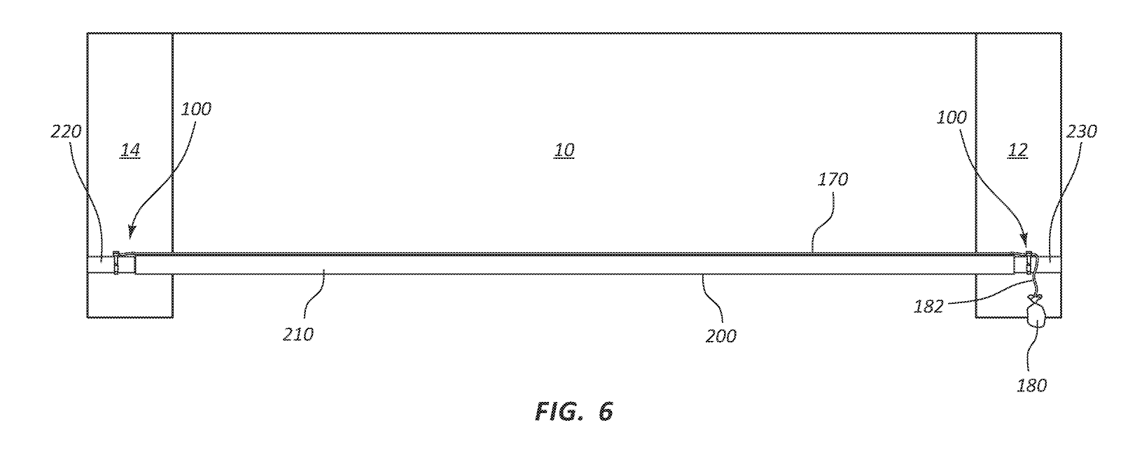

In the configurations shown in FIG. 5, a conductive plate 140 may be provided in the base 124. The conductive plate 140 may include spikes or other features to pierce through an outer jacket of a tracer wire 170, 182 to put the conductive plate 140 in electrical communication with an internal conductor of the tracer wire. In some embodiments, the wire terminal 120 may have only a single wire opening 152, two openings 152, 154 (such as the illustrated embodiments), or three or more wire openings for use with “T” or “X” connections in the utility pipe. In some embodiments, the wire terminal 120 may be filled with a sealant gel or other material that still allows for electrical contact with the conductor in the tracer wire, but otherwise protects the conductive plate 140 from corrosion. The tracer wire 170, 182 may be a HDPE jacketed wire that is designed and configured to be buried underground.

As shown in FIGS. 1-2, a contact 130 may be used to connect the wire terminal 120 to the clamp 110. The contact 130 may be a rivet, screw, or other suitable fastener connecting conductive plate 140 with the clamp 110. In some embodiments, the contact 110 may extend through the clamp 110 to contact anything that the clamp is attached to, such as a metal service pipe 230, 220 as shown in FIG. 6.

Because the electric signal can pass through the tracer wire 170, wire connector device 100, and metal service pipes, as well as the movement of gas or fluids in the service pipes, a sacrificial anode 180 may be used to prevent corrosion of the functional parts in the system. In some embodiments, therefore, the sacrificial anode 180 may be connected to the tracer wire 170 and the wire connector device 100 via anode wire 182 to prevent corrosion of the service pipes 220, 230, the conductive plate 140, the clamp 110, or any other metal components in the system. The anode 180 may be formed of zinc, magnesium, and/or any other sacrificial anode material. The anode 180 may be held in a protective bag and may be placed at a connection in a service hole for periodic inspection and replacement as needed.

One embodiment of an installation of a tracer wire is shown in FIG. 6. A tracer wire 170 may be installed along with a plastic main utility pipe 200. The main utility pipe 200 may be connected at each end to the metal pipes 220, 230. The tracer wire 170 may be electrically connected to the metal pipes at each end using wire connector devices 100. Each of the wire connector devices may function as described herein to provide electrical continuity from metal pipe 220 to metal pipe 230 so that a signal placed on tracer wire 170 may be detected along the length of the utility pipe 200 and the metal pipes 220, 230. The anode 180 may be provided at one or both ends. In the illustrated embodiments, each connection of the tracer wire through the wire connector devices 100 is shown in a service hole. However, in other embodiments, one or both connections may be buried.

By using the wire connector devices 100 as described above, a quick and simple solution to providing a path for a signal along a tracer wire installed with a plastic utility pipe connected to metal service pipes can be provided.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

1. An underground tracer wire device configured to connect a tracer wire to an underground utility pipe, comprising:
a clamp; and
a wire connector coupled to the clamp, the wire connector including a conductive plate in electrical communication with an interior portion of the clamp.

2. The device of claim 1, wherein the tracer wire device is confirmed to be attached to an underground utility pipe comprising a natural gas supply line.

3. The device of claim 2, wherein the wire connector electrically couples an underground tracer wire to the underground utility pipe.

4. The device of claim 3, wherein the underground utility pipe comprises a continuous section formed of plastic.

5. The device of claim 1, wherein the clamp comprises a screw-type clamp formed of metal.

6. The device of claim 1, wherein the wire connector is coupled to the clamp with an electrically conductive rivet.

7. The device of claim 1, further comprising a sacrificial anode electrically coupled to the wire connector.

8. The device of claim 7, wherein the sacrificial anode comprises zinc or magnesium.

9. The device of claim 1, wherein the wire connector comprises a base and a cap coupled to the base with a strap, wherein when the cap is placed on the base and the tracer wire is electrically connected to the conductive plate.

10. A method of connecting a buried tracer wire to a buried utility pipe, comprising:
providing a tracer wire connector that is connected to a clamp;
attaching the clamp to a metal portion of a buried utility pipe; and
placing an end of the buried tracer wire in the tracer wire connector such that a conductor in the tracer wire is in electrical communication with the buried utility pipe.

11. The method of claim 10, further comprising covering the end of buried the tracer wire with a cap.

12. The method of claim 11, wherein covering the end of the buried tracer wire places the buried tracer wire in electrical communication with the buried utility pipe.

13. The method of claim 12, wherein the tracer wire connector comprises a conductive plate coupled to the clamp with a conductive contact.

14. The method of claim 13, wherein the conductive contact is in direct physical contact with the metal portion of the buried utility pipe.

15. The method of claim 10, wherein the buried utility pipe comprises a non-conductive section concurrent with a portion of the buried tracer wire.

16. The method of claim 10, further comprising electrically attaching a sacrificial anode to the tracer wire connector.

17. The method of claim 16, wherein the sacrificial anode comprises zinc or magnesium.

18. The method of claim 16, wherein the sacrificial anode is attached to the tracer wire connector using a jacketed wire.

19. The method of claim 10, further comprising:
attaching a second clamp to a second metal portion of the buried utility pipe; and
placing a second end of the buried tracer wire in a second tracer wire connector such that the conductor in the tracer wire is in electrical communication with the metal portion of the buried utility pipe and the second metal portion of the buried utility pipe.

20. A system for detecting an underground utility line, the system comprising:
an underground utility line; and
an underground tracer wire device connecting a tracer wire to the underground utility line, the device comprising:
a clamp; and
a wire connector coupled to the clamp, the wire connector including a conductive plate in electrical communication with an interior portion of the clamp.
